(19) United States
(12) Patent Application Publication
(10) Pub. No.: US 2006/0162420 A1
(43) Pub. Date: Jul. 27, 2006

(54) Friction coefficient measuring system and method

(76) Inventors: John Christopher Pappas, Saint John (CA); Thomas D. Watters, Quispamsis (CA); M. Hassan Loutfi, Rothesay (CA)

Correspondence Address: BERESKIN AND PARR, 40 KING STREET WEST, BOX 401, TORONTO, ON, M5H 3Y2, CA

(21) Appl. No.: 11/274,735

(22) Filed: Nov. 16, 2005

Related U.S. Application Data
(60) Provisional application No. 60/646,577, filed on Jan. 25, 2005.

(51) Int. Cl. G01N 19/02

(52) U.S. Cl. 73/9

(57) ABSTRACT

A friction sled for measuring the co-efficient of friction between a friction pad mounted to the friction sled and test surface. The friction sled includes a load cell. A displacement force is applied to the friction sled and is measured by the friction cell. The friction cell is coupled to a controller that calculates the co-efficient of friction based on the displacement force and the weight of the friction sled.

### FIELD OF THE INVENTION

This invention relates to a friction coefficient measuring system and method. More particularly, the invention relates to a friction sled, which can be used to determine the coefficient of friction of a test surface.

### BACKGROUND OF THE INVENTION

The speed at which an automobile was traveling immediately before or during an accident is, in many cases, critical to the accident's investigation. Speed estimates are necessary to properly reconstruct the accident and to correctly assign liability to those involved. A police officer or investigator can use the coefficient of friction between the vehicle in question and the surface where the skid occurred to estimate the speed at which the automobile was traveling. These friction measurements are often used as evidence in a court of law.

The coefficient of friction, designated by μ (mu), between an object and a test surface can be calculated by dividing the friction force, F_{F}, by the normal force, F_{N}, applied to the object:
μ=F_{F}/F_{N}
The friction force equals the amount of force it takes to move an object on a surface at a steady rate and is measured parallel to the surface being tested. The normal force is the force applied to the object by the surface and is measured in the direction that is normal, or perpendicular, to the surface being tested. For a horizontal surface, the normal force generally equals the weight of the object.

Those who investigate or are involved in the reconstruction of highway traffic accidents have used a variety of devices to measure the coefficient of friction for a road surface. One known device is a mechanical friction sled. These mechanical friction sleds are simple devices that are pulled along the road surface at a constant speed. They are of a known weight and use a spring scale to measure the friction force, through which the coefficient of friction may be calculated.

However, many difficulties are experienced with prior art friction sleds. Among the largest of these difficulties is that they are time consuming; because of the limitations of a spring scale, only one measurement can be taken per pull. Many measurements must be taken to ensure a reliable data set.

Further, the devices are inaccurate. They have a tendency to pitch, wobble or chatter during a pull because their weight is typically unevenly distributed. The use of spring scales also allows the user to pull off center, possibly affecting the applied force. Moreover, spring scales have a tendency to “loosen” after extended use, requiring regular manual calibration. The use of spring scale requires the user to visually read a rapidly fluctuating needle dial, or digital readout during a test. This assumes an average pull force during a test based on visual estimations.

Traditional friction sleds that use a force gauge with a maximum force indicator are much more easily used to measure the static breakaway force on a particular surface, which allows the coefficient of static friction to be calculated rather than the coefficient of kinetic friction. The coefficient of kinetic friction is relevant to the speed of a vehicle that is skidding on a surface. The breakaway force is normally greater than the force required to maintain an object at a constant speed sliding on a surface and accordingly, these traditional friction sleds tend to provide an inaccurately high kinetic friction coefficient.

Traditional friction sleds also do not have the ability to store or manipulate measurement data, except for the maximum force measured by the spring scale (which as noted above corresponds to the static rather than the kinetic coefficient of friction). Other types of friction measurement devices, which have used other force measuring means, have these capabilities. However these other devices lack the portability and simplicity of traditional friction sleds.

Therefore there is a need for an improved portable friction sled that is easy to use, reliable and has the ability to measure the coefficient of kinetic friction for a surface by taking and incorporating multiple measurements. Preferably, the improved friction sled also has the ability to store and manipulate measurement data. Preferably, the improved friction sled does not have the inherent flaws that are associated with the use of a spring scale.

### SUMMARY OF THE INVENTION

In accordance with one aspect of the invention, there is provided a friction sled for estimating the coefficient of friction of a test surface. The friction sled comprises a housing having a bottom surface; a friction pad mounted on the bottom outside surface of the housing; a displacement means for applying a displacement force to the friction sled; a load cell for measuring the displacement force and for providing force information; a weight mounted to the housing, wherein the friction sled has a test mass; a data output device. It further comprises a controller for: receiving the force information from the load cell; calculating test result data; and providing the test result data at the data output device.

In accordance with a second aspect of the invention, there is provided a method for obtaining an estimated friction coefficient for a test surface comprising a friction sled as described above. The method involves measuring a displacement force applied to the friction sled using the load cell, wherein the displacement force is applied generally parallel to the test surface. It further involves receiving force information from the load cell and calculating test result data from force information, wherein the test result data corresponds to the estimated friction coefficient. It further involves providing the test result data at an output device.

As will be apparent, the friction sled of the present invention, while especially adapted for automobile accident investigations, the system may be used in a number of other situations in which it is necessary to determine the coefficient of friction, including test surfaces such as a sidewalk, airway strip, or any other indoor or outdoor surface.

### BRIEF DESCRIPTION OF THE DRAWINGS

A preferred embodiment of the present invention will now be described in detail with reference to the drawings, in which:

FIG. 1 is a perspective view of the friction sled of an embodiment of the present invention;

FIG. 2 is a front view thereof;

FIG. 3 is a side view thereof;

FIG. 4 is a top view thereof;

FIG. 5 is a back view thereof;

FIG. 6 is a cross-sectional view at lines 5-5 in FIG. 2;

FIG. 7 is a schematic view of the friction coefficient measuring system; and

FIG. 8 is a perspective view of the friction sled of an embodiment of the invention.

### DETAILED DESCRIPTION OF EXEMPLARY EMBODIMENT

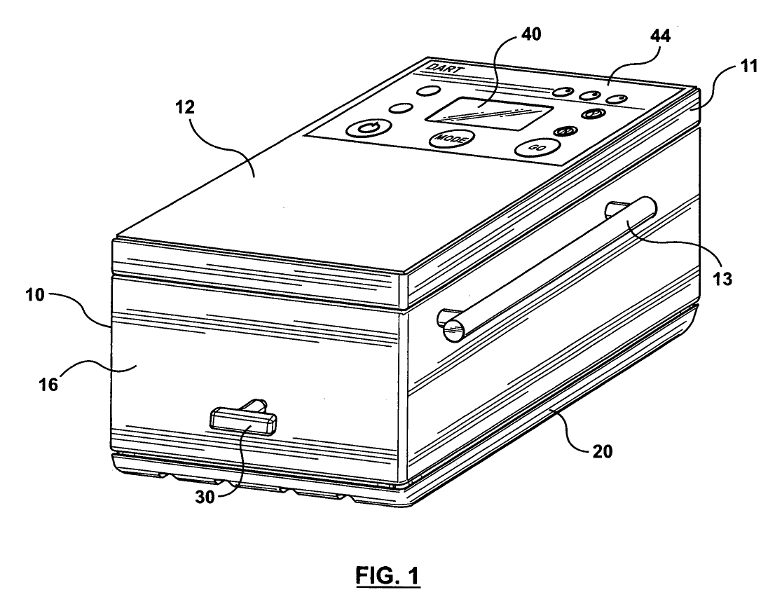

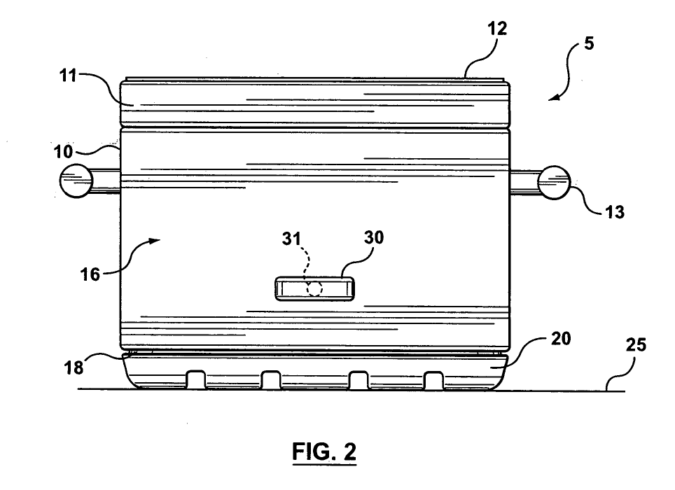

Reference is first made to FIGS. 1-5, which illustrate an exemplary friction sled 5 according to the present invention. Friction sled 5 has a housing 10 which has a front side 16, back side 17, a left and right side, a bottom surface 18. Housing 10 also has a housing lid 11 that is secured to the top of the housing 10. In this embodiment, housing 10 and housing lid 11 are constructed of cast aluminum and together, with a waterproof cover 12 provide a watertight interior, which protects instrumentation inside from the environmental elements. Two handles 13 are attached on the left and right side of the housing 10. Handles 13 are an optional element of this embodiment and may be used to carry friction sled 5.

The bottom surface 18 is relatively flat and has a friction pad 20 mounted on it. When friction sled 5 is in use, friction pad 20 frictionally engages a test surface 25. Since the coefficient of friction between two surfaces is dependent on the characteristics of the surfaces, the friction pad 20 is interchangeable to adapt to the application at hand. The present embodiment of the invention is intended for use in estimating the friction coefficient of a road surface or any other surface that a vehicle may be skidding on. In the present embodiment, friction pad 20 is a piece of tire tread dimensioned to simulate the size of the actual contact area between an automobile tire and a surface an automobile tire is skidding, such as a road. Further the friction pad 20 is chamfered at its leading edge 21 to reduce plowing on more movable surfaces such as grass and loose gravel.

Friction sled 5 has a pull handle 30 mounted on its front side 16. The pull handle 30 is a displacement means that may be used to pull friction sled 5 across a test surface 25, when the friction sled is in use. The use of pull handle is further described below. In the preferred embodiment, the displacement of the friction sled 5 is accomplished by manually pulling on the pull handle 30. However, displacement may also be a result of pushing the friction sled 5. In both situations, it is required that any displacement means 30 allow for a uniform pulling force to be exerted on the friction sled 5.

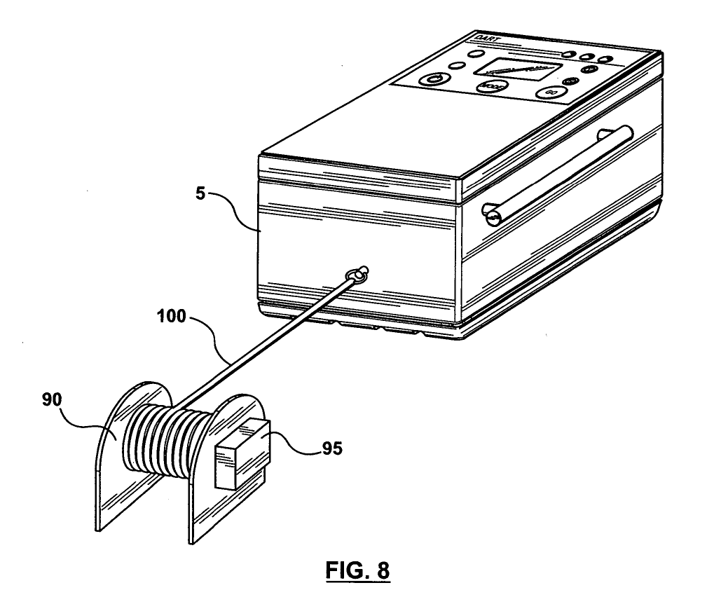

Referring to FIG. 8, in another embodiment of the invention, the displacement means may be an electrically operated winch 90 that is used to pull the friction sled 5 across a test surface 25. Winch 90 has an electric motor that retracts cable 100 at a constant speed, thereby ensuring that friction sled 5 travels on test surface 25 at a constant speed.

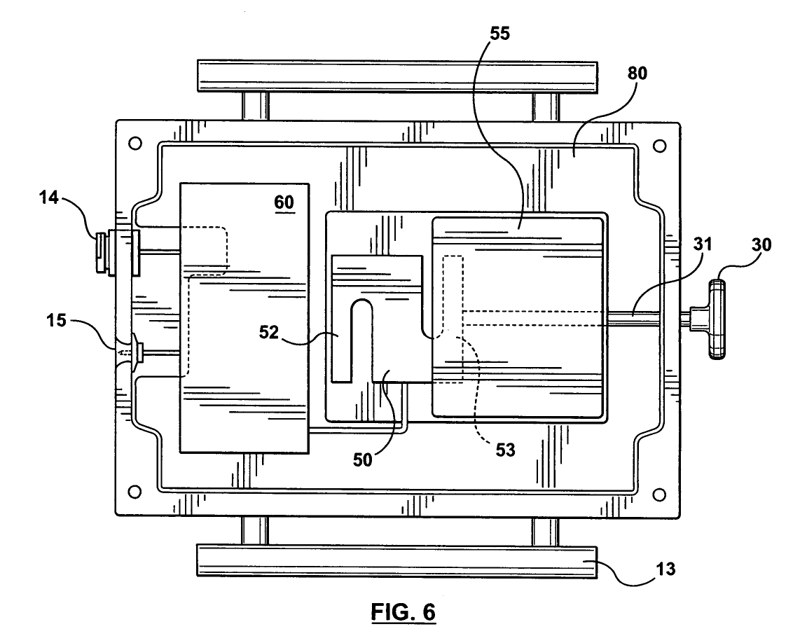

Reference is now made to FIG. 6, which illustrates the housing 10 with the housing lid 11 removed, revealing the internal components of friction sled 5. Friction sled 5 includes a load cell 50. Load cell 50 is a transducer that converts the force applied to the cell into a measurable electrical output. In the present invention, the load cell 50 contains an analog to digital converter. Optionally, an analog to digital converter may be couple between the load cell 50 and controller 60.

There are a variety of types of load cells and the invention is not limited to the use of any particular type or configuration of load cell. In this embodiment, load cell 50 is an S-type of conventional design, which uses strain gauges. Any other type of strain gauge load cells may be used with the invention including, but not limited to, button or shear-beam types. The load cell 50 is preferably configured to measure tensile forces, however measurement of compressive forces is also possible.

The load cell 50 has a fixed side 52 and a free side 53. The fixed side 52 is mounted to the housing 10 of the friction sled, so that the fixed side 52 moves together with the housing 10. Pull handle 30 is coupled to the free side 53 of the load cell 50 through a pull rod 31. Pull rod 31 extends through an aperture in the front side 16 in a manner that aligns the pull rod with the longitudinal direction of the friction sled 5, which is the direction in which the friction sled travels during a test. This prevents the pull handle 30 from applying a force to the load cell other than in the same direction that the friction sled 5 is being displaced. Thus, the load cell 50 only measures the component of the force that is in the same direction the friction sled 5 is being displaced. Load cell 50 measures a force applied to the pull handle 30 and provides a measurement of the force. Skilled persons will understand the construction of a load cell and the components and operations required to convert the force applied to the load cell 50 into a corresponding force measurement.

Housing 10 includes a weight 80. In the present embodiment, weight 80 is machined to fit inside housing 10 around its perimeter without contacting or interfering with the remaining components of the friction sled. Weight 80 is mounted to housing 10 by means of fasteners such as screws, bolts, glue or other adhesives, pins clips, etc. In the present embodiment, weight 80 consists of several separate steel pieces. In other embodiments, the weight 80 may be formed from a single piece of material and may be made of any material capable of providing sufficient weight to the friction sled.

The weight 80 combined with the mass of rest of the friction sled 5 provides the test mass of the friction sled 5. The ideal range of the test mass of the friction sled 5 is 28-30 lbs. The preferred range of the test mass of the friction sled 5 is 25-30 lbs. An acceptable range of the test mass of the friction sled 5 is 20-30 lbs.

It is preferable to provide the friction sled with a balanced weight 80 to reduce chatter when the friction sled is pulled across test surface 25. Most preferably, the center of mass of the friction sled (including all components of the friction sled) is positioned at about the longitudinal midpoint of the housing 10 (with the longitudinal or lengthwise direction being defined between the front side 16 and the back side 17).

In the present embodiment, load cell 50 is positioned adjacent to the center of mass of the friction sled. Preferably the load cell is positioned within about 10% of the length of the friction sled from the center of mass, in the longitudinal direction. The load cell 50 is accordingly positioned near the midpoint of the housing 10 in the lengthwise direction. In the vertical direction, the load cell 50 is preferably positioned adjacent or below the center of mass of the friction sled. In this position, the load cell 50 eliminates a moment of inertia that imparts a force downward on the leading edge of the friction pad 20, which could result in chatter and unreliable force information.

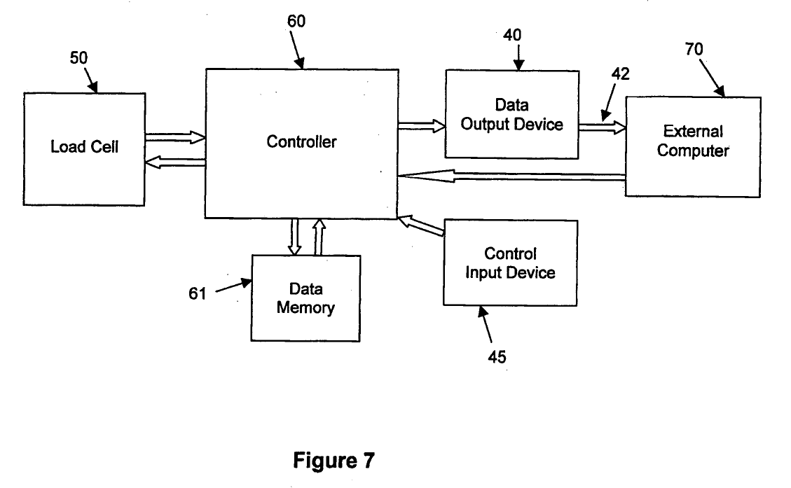

Reference is now made to FIG. 7, which illustrates a schematic view of the friction coefficient measuring system. The load cell 50 provides force information to the controller 60 based on the force applied to pull handle 30. In the present embodiment, the controller 60 is secured to the inside face of the housing lid 11 (FIG. 6) although it could be secured to another part of the housing 10. The controller 60 calculates test result data from the force information and provides the value to a data output device 40. The calculation of the test result data is further explained below. In the present embodiment, the data output device 40 is a display screen (FIGS. 1,4). Alternatively, the data output device 40 may be coupled to the controller 60 through a connection port. For example the data output device may be an externally coupled display screen or printer (which may be used to create a detailed and permanent record of force information or test results or both). Other friction sled according to the present invention may include any combination of built-in or external display screens or printers.

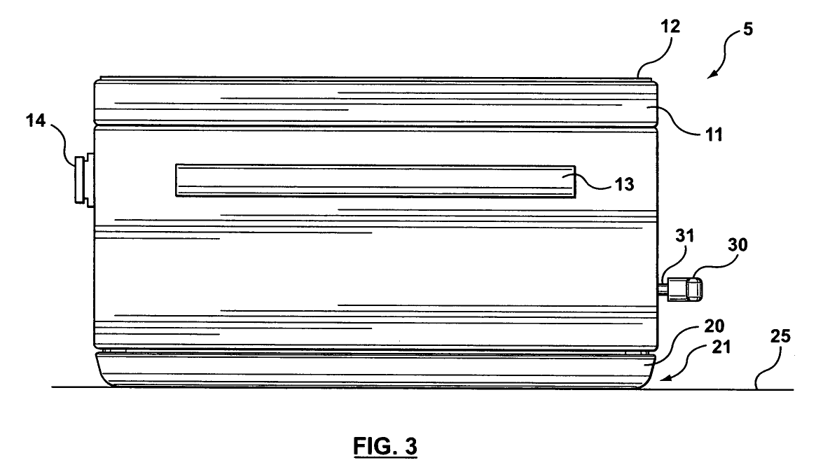

In the present embodiment, the data output device 40 may also be a data output terminal 14 (FIGS. 3,4) for connecting to an external computing device 70 and for transmitting the test result data to the external computing device 70. In the present embodiment, the data output terminal 14 is a wireline data transmission device 42 that may be coupled to an Ethernet communication network terminal. In other embodiments the wireline data transmission device may be a USB port or another type of serial or parallel data communication port. Alternatively, the data output terminal 14 may be a wireless data transmission device.

The test result data may be recorded in a data memory 61. In the preferred embodiment, the data memory 61 is a part of the controller 60. Data is stored for access by the display screen 40, or can be deleted or transferred to an external computer 70 at the command of the operator. Alternatively, test result data may be transferred to an external flash memory device. Once transferred to an external computer 70, data can be further arranged, sorted, graphed and reported upon using the external computer 70. Computed data may be thereafter transferred to a secondary computer for further analysis.

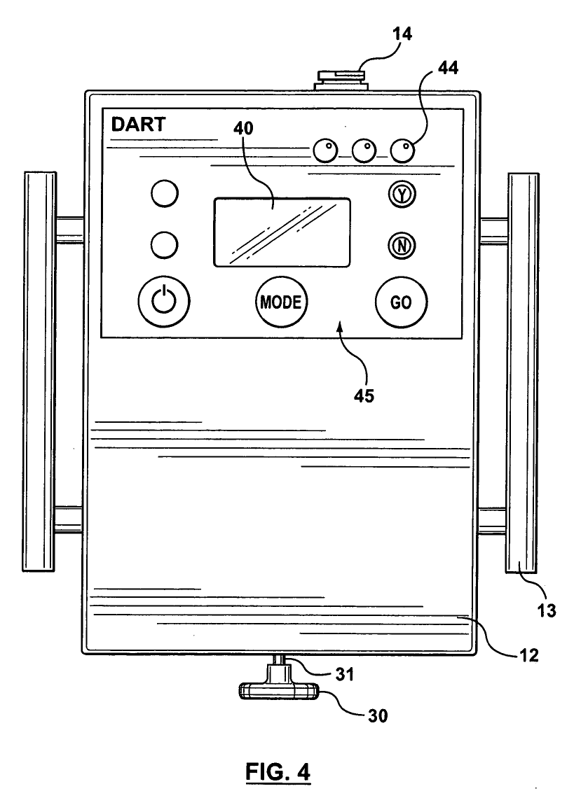

Referring again to FIG. 4, the housing lid 11 is fitted with access holes to accommodate display screen 40. Mounted to the top of the housing lid 11 is a waterproof cover 12. It provides a waterproof seal for the access holes in the cover that connect the display screen 40 and the controller 60. In the preferred embodiment, the waterproof cover is a made of a waterproof material, such as Lexan™.

The waterproof cover 12 also covers a control input device 45, through which the user directly enters commands to the controller 60. The control input device 45 is coupled to the controller 60 for inputting control instructions, wherein the controller 60 is configured to receive the force information in accordance with the control instructions. In the present embodiment, the control input device 45 is a keypad, which is part of the waterproof cover 12.

The waterproof cover 12 also includes a visual alert 44 and corresponding tone alert to assist in the correctly applying force to the friction sled 5. These audio/visual alerts facilitate the use of friction sled 5 at night and in high noise environments.

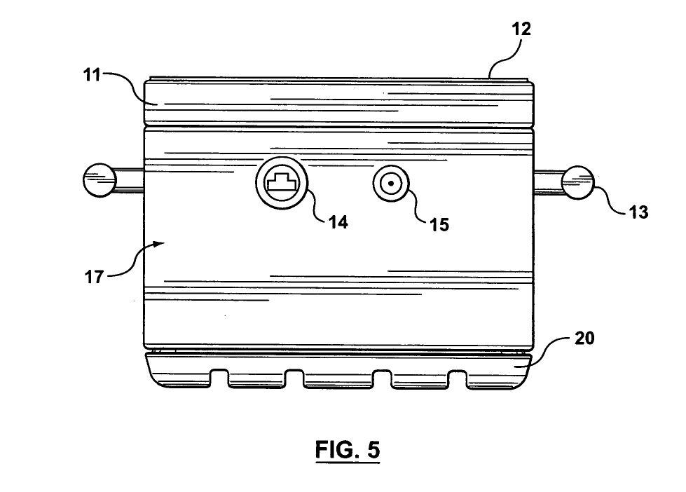

There is a rechargeable battery 55 inside the housing 10, which powers the load cell 50, LCD screen, and controller 60. Rechargeable battery 55 is charged through recharge port 15 on the back side 17 of the housing 10 (FIG. 5). A battery ensures that during measurement there are no power cords contributing to the friction measurement. Alternatively, the battery could be replaceable by the user.

The process of obtaining an estimated coefficient of kinetic friction for a test surface will now be described.

The friction sled is placed on the test surface 25 so the friction pad 20 is resting generally flat on the test surface 25. A user initiates the test by pressing a “Start” or “Go” or other similar button on the control input device 45. The controller signals the start of the test by emitting a tone and providing a visual indicator that the test has begun. The user applies a displacement force to the friction sled 5 in a direction generally parallel to the test surface 25 by pulling pull handle 30. The displacement force will be considered generally parallel to the test surface if it does not substantially affect the normal force applied to the friction sled 5 by the test surface 25. The displacement force should be just enough to move the friction sled 5 and maintain it in motion at an approximately constant speed. A typical pull speed is 0.5-1.5 feet per second.

The load cell 50 measures the displacement force applied between the pull handle and the friction sled's housing 10 and generates corresponding force information, which is provided to the controller 60. The controller 60 calculates an estimated coefficient of friction to produce test result data. In an accident reconstruction situation, the controller 60 is also configurable to calculate the speed at which the vehicle was traveling using a well known formula requiring the distance at which the vehicle skidded.

During a single test, which may typically last from 2 to 8 seconds, load cell 50 may provide a series of 100, to as high as 5000, measurements of the displacement force each second, depending on the sample rate set by the user. Controller 60 calculates a corresponding coefficient measurement based on the weight of the friction sled and the average displacement force. The length of a single test, the number of measurements of displacement force each second, and the weight of the friction sled are each configurable by the user.

In the present embodiment, the calculation of the average displacement force preferably ignores data received during the first and last 0.5 seconds of the test, although the time values in which data is ignored are configurable by the user. The controller calculates the average displacement force in this way as to only measure the period of kinetic friction between the friction pad 20 and the test surface 25. This puts the focus on steady movement across the test surface 25, and discards forces resulting from overcoming static friction, as well as from any slowing down that may occur at the end of the test.

For example, during a test lasting 2 seconds, the samples provided between 0.5 to 1.5 seconds after the beginning of the test are used to calculate an average displacement force. This average force is used to produce a final estimate of the coefficient of kinetic friction, which the controller records in memory 61 as the test result data. The controller may also record each of the displacement force values or the average displacement force, or the individual calculations of the estimated kinetic friction, or some or all of these data.

The test result data is then presented on the output device 40. The test result data can be viewed on the LCD screen and can be saved or deleted on command of the user via the control input device 45. In the present embodiment, the test result data and force information that is saved in the data memory 61 and can also be provided by the controller 60 to an external computer 70 via output data connection 42.

In other embodiments of the invention, the housing 10 may be made of plastic or any other suitable material. It will also be appreciated that the friction pad 20 may be made of metal, fiberglass or other material that simulates the roof, or other parts, of a vehicle. Further, any variety of tire tread may be used.

The friction pad 20 is adaptable to measure the friction coefficient for situations other than accident reconstruction. The friction pad 20 may be made of leather or other material that is used to make the sole of a shoe to measure the friction coefficient in a slip-and-fall situation. The friction sled 5 may also be used in the construction industry to determine a desirable composition of asphalt or concrete. The friction sled may be used indoors or outdoors.

It will further be appreciated that the controller and display may be detachable and may take the form of any portable handheld computer.

The present invention has been described here by way of example only. Various modification and variations may be made to these exemplary embodiments without departing from the spirit and scope of the invention, which is limited only by the appended claims.

We claim:

1. A friction sled for estimating the coefficient of friction of a test surface comprising:
(a) a housing having a bottom surface;
(b) a friction pad mounted on the bottom surface of the housing;
(c) a displacement means for applying a displacement force to the friction sled;
(d) a load cell for measuring the displacement force and for providing force information;
(e) a weight mounted to the housing, wherein the friction sled has a test mass;
(g) a data output device; and
(h) a controller for:
(i) receiving the force information from the load cell;
(ii) calculating test result data; and
(iv) providing the test result data at the data output device.

2. The friction sled of claim 1 wherein the data output device is a data output terminal for coupling an external computing device and for transmitting the test result data to the external computing device.

3. The friction sled of claim 1 wherein the data output device is a display screen coupled to the controller.

4. The friction sled of claim 1 wherein the data output device is a printer coupled to the controller.

5. The friction sled of claim 1 further comprising a data memory coupled to the controller and wherein the controller is configured to record the test result data in the data memory.

6. The friction sled of claim 1 wherein the test mass of the friction sled is between 28 to 30 pounds.

7. The friction sled of claim 1 wherein the test mass of the friction sled is between 25 to 30 pounds.

8. The friction sled of claim 1 wherein the test mass of the friction sled is between 20 to 30 pounds.

9. The friction sled of claim 1 wherein the friction sled has a center of mass and wherein the load cell is positioned within about 10% of the length of the housing from the center of mass in the longitudinal direction.

10. The friction sled of claim 1 wherein the load cell is positioned adjacent the center of mass in the vertical direction.

11. The friction sled of claim 1 wherein the load cell is positioned below the center of mass in the vertical direction.

12. The friction sled of claim 1 further comprising:
(i) a control input device coupled to the controller for inputting control instructions, wherein the controller is configured to receive the force information in accordance with the control instructions.

13. The friction sled of claim 1 wherein the data output terminal is a wireless data transmission device.

14. The friction sled of claim 1 wherein the data output terminal is a wireline data transmission device.

15. The friction sled of claim 1 further comprising a
(j) an output device coupled to the controller for displaying information relating to the test result data.

16. The friction sled of claim 1 wherein the friction pad has a chamfered leading edge.

17. The friction sled of claim 1 wherein the displacement means is coupled to the load cell through a pull rod and wherein the pull rod is aligned with the longitudinal direction of the friction sled.

18. A method of obtaining an estimated friction coefficient for a test surface comprising:
(a) providing a friction sled having a housing having a bottom surface; a friction pad mounted on the bottom outside surface of the housing; a displacement means for applying a displacement force to the friction sled; a load cell for measuring the displacement force and for providing force information; a weight mounted to the housing, wherein the friction sled has a test mass; a data output device; and a controller for: receiving the force information from the load cell; calculating test result data; and providing the test result data at the data output device;
(b) applying a displacement force to the displacement means in a direction generally parallel to the test surface;
(c) measuring the displacement force applied to the friction sled using the load cell;
(d) receiving force information from the load cell and calculating test result data from force information, wherein the test result data corresponds to the estimated friction co-efficient;
(e) providing the test result data at an output device.

19. The method of claim 18 further including storing the test result data in the data memory.

20. The method of claim 18 wherein the output device is a data output terminal for coupling an external computing device and for transmitting the test result data to the external computing device.

21. The method of claim 18 further including providing the force information at an output device.

22. The method of claim 18 further including aligning the pull rod with a longitudinal direction of the friction sled and, during step (b), dragging the sled in the longitudinal direction at a generally constant speed.
